(19) United States
(12) Patent Application Publication
(10) Pub. No.: US 2008/0078328 A1
(43) Pub. Date: Apr. 3, 2008

(54) INSECT DUSTING APPARATUS AND METHOD

(76) Inventor: Erik Stratford Orup, Los Gatos (CA)

Correspondence Address: Patent Law Office of Larry Guernsey, P.O. Box 720247, San Jose, CA, 95172-0247, US

(21) Appl. No.: 11/538,202

(22) Filed: Oct. 3, 2006

(51) Int. Cl. A01K 39/00

(52) U.S. Cl. 119/51.01

(57) ABSTRACT

An insect dusting apparatus is disclosed which includes a dusting enclosure surrounded by cylindrical walls, a lower cap, and an upper cap. The upper cap includes a closable insertion aperture through which an extraction tube may be inserted. An insect enclosure and a supplements chamber included in the dusting enclosure are connected by openings in a pour grille which separates them. Crickets are introduced into the insect enclosure, nutrient powders are placed in the supplements chamber, and the dusting enclosure is shaken to dust the crickets. When the crickets are to be dispensed, an extraction tube is inserted into the insect enclosure through the insertion aperture. Crickets climb into the interior of the extraction tube, which is then removed from the insertion aperture, and the cover segment closes the insertion aperture. The extraction tube can then be shaken over the reptile's terrarium to dislodge the crickets

### TECHNICAL FIELD

The present invention relates to apparatus for facilitating the feeding of reptiles. More particularly, this invention pertains to a device for coating live crickets with nutrient dusts to prepare them for serving as food to reptiles.

### BACKGROUND ART

Reptiles are becoming more and more popular as pets. It is estimate that several million households in the US alone have at least one reptile as a pet. These reptiles may include bearded dragons, chameleons, monitors, iguanas and others.

The cricket, which is easily available in many pet supply stores, is an integral part of the diet of most reptiles. These are commonly bought in packages by the owner and then dispensed to the reptile pet. However, as most reptiles living in the wild have access to the more varied diet provided by their environment, they are used to supplying themselves with various nutrients which cannot be obtained by a steady diet of crickets alone. As with any animal who is not getting a balanced diet containing all of the essential vitamins and nutrients for good health, a deficiency of these nutrients can lead to illness and shortened life expectancy. Thus, to maintain the health of their pets, the pet owner may be required to provide supplements such as calcium, and other vitamins and nutrients, such as are found in such supplement mixtures as nutrient additives or other commercial supplements.

It can be imagined that the easiest way to persuade a reptile to consume essential nutrients is by introducing it into its food, including live crickets. Again, it can be imagined that adding nutrient supplements to a group of live crickets can be challenging. In addition, collecting and dispensing the correct number of crickets, especially if they have been treated with nutrient supplements, can be especially difficult.

Thus there is a need for an apparatus which can easily apply nutrients to live crickets and which makes the management and dispensing of the crickets easy and less messy.

### DISCLOSURE OF INVENTION

Accordingly, it is an object of the present invention to provide an apparatus for coating insects with nutrient powders for feeding to domestic reptiles.

It is another object of the present invention to provide an apparatus which makes dispensing of dusted insects easier and less messy.

It is a further object of the present invention to provide an apparatus which minimizes handling of the food insects.

It is an additional object of the present invention to provide an apparatus with an extraction tube which aids in the dispensing of dusted insects.

It is yet another object of the present invention to provide an insect enclosure with a re-closable cover with an aperture through which an extraction tube can be inserted and withdrawn.

It is another object of the present invention to provide a dusting enclosure with a re-closable cover which can be shaken to dust insects without nutrient powder escaping from the dusting enclosure.

Briefly, one preferred embodiment of the present invention is an insect dusting apparatus which includes a dusting enclosure, surrounded by a container having cylindrical walls, a lower cap, and an upper cap. The upper cap includes an insertion aperture and a cover segment which closes the insertion aperture. Within the dusting enclosure are contained an insect enclosure and a supplements chamber, which are connected by openings in a pour grille which separates them. Crickets are introduced into the insect enclosure, nutrient powders are placed in the supplements chamber, and the dusting enclosure is shaken to introduce the nutrient powders into the insect enclosure to coat the crickets.

When the crickets are to be dispensed, the cover segment is moved to open the insertion aperture, and an extraction tube is inserted through the insertion aperture into the insect enclosure. The inner surface of the extraction tube has a textured inner surface which aids crickets to climb into the interior of the extraction tube. The extraction tube is then removed from the insertion aperture, and the cover segment is rotated to close the insertion aperture. The extraction tube can then be shaken over the reptile's terrarium to dislodge the crickets, or the entire extraction tube can be placed into the terrarium with the cap removed. Alternately, the extraction tube may be left in place extending into the insect enclosure with the extraction tube's cap removed, so that reptiles such as chameleons can then feed on crickets which climb to the open top of the tube.

An advantage of the present invention is that it includes a container which is sealable to contain nutrient dust during shaking, but includes an uncoverable insertion aperture through which an extraction tube may be inserted, to extract insects which have been dusted.

Another advantage of the present invention is that the extraction tube is insertable at a non-vertical angle, so that insects may more easily climb the interior of the extraction tube.

And another advantage of the present invention is that the interior of the extraction tube has textured regions which help the crickets to climb the interior of the extraction tube for easier extraction.

A further advantage of the present invention is that once the extraction tube contains the desired number of insects, it can be withdrawn through the insertion aperture, and the aperture covered to retain the remaining insects within the container.

A yet further advantage is that a cover segment is rotatably attached to cover and uncover the insertion aperture, and this cover segment is provided with first and second stops to limit its travel from a first position in which the cover segment covers the aperture to a second position, where the aperture is uncovered.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows an isometric view of the cricket shaker with extraction tube of the present invention;

FIG. 2 shows an exploded side view of the container of the present invention;

FIG. 3 illustrates a top plan view of the upper cap of the present invention;

FIG. 4 shows a top plan view of the container and bottom cap of the present invention;

FIG. 5 illustrates a bottom plan view of the bottom cap of the present invention;

FIG. 6 shows a side plan view of the container and extraction tube of the present invention; and

FIG. 7 shows an isometric view of the extraction tube of the present invention.

### BEST MODE FOR CARRYING OUT THE INVENTION

The present invention is an apparatus for applying nutrient power or other particulate matter to live insects which are to act as food for reptiles. The present invention will be referred to by the element number 10 and referred as the cricket duster 10.

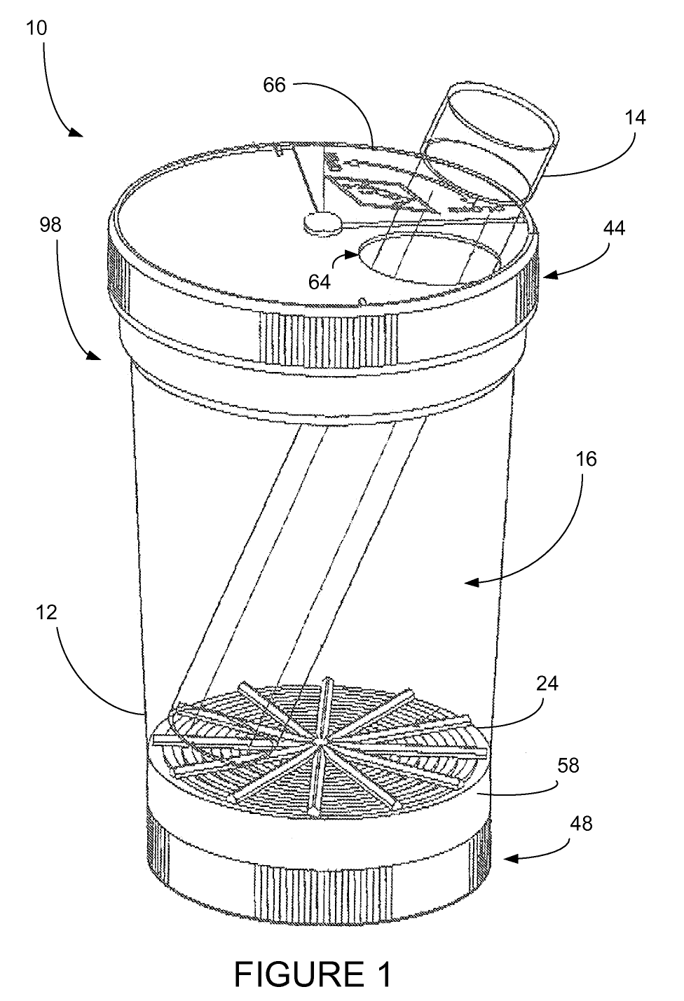

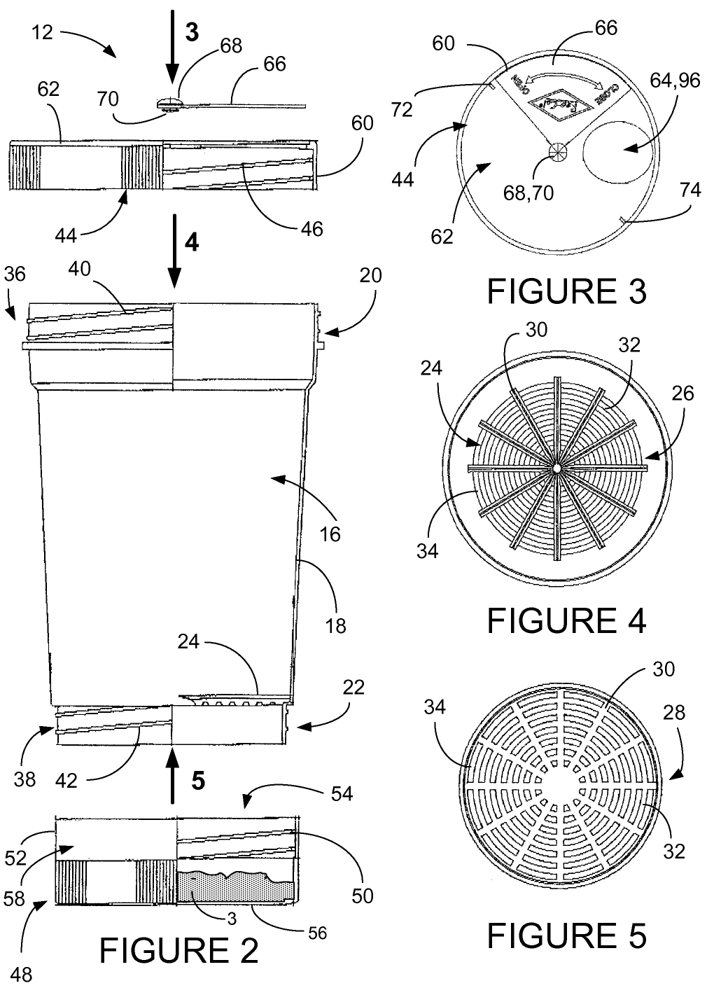

The cricket duster 10 is illustrated in FIGS. 1-7, which will be referred to generally in the following discussion. FIG. 1 shows an isometric view of the cricket duster 10, which has two major components, a container 12 and an extraction tube 14. An exploded view of the container 12 with partial cut-aways of various features is shown in FIG. 2. The main body of the container 12 has an insect enclosure 16 area for containing crickets or other insects, as will be discussed below. The container 12 preferably includes slightly tapered cylindrical side walls 18 having an open top 20 and a partial closed bottom 22. This bottom 22 includes a pour grille 24 which is preferably permanently fixed in place. FIGS. 4 and 5 show top and bottom views of the container 12, in which the pour grille 24 can be seen. The pour grille 24 has a top face 26 and a bottom face 28. The pour grille 24, as can be more easily seen from the top view FIG. 4, has a number of radial supports 30, as well as a number of concentric members 32. These radial supports 30 and concentric members 32 surround a number of slots or openings 34 through which nutrient dusts can be introduced into the insect enclosure 16, as will be discussed later.

The container 12 also includes an upper lip portion 36 and a lower lip portion 38 having upper screw threads 40 and lower screw threads 42 respectively. An upper cap 44 includes a mating set of screw threads 46, by which the upper cap 44 can be releasably fastened to the container 12 by screwing on. There is also a lower cap 48, also with a mating set of screw threads 50, by which the lower cap 48 can be releasably fastened to the lower lip 38 of the container 12. The lower cap 48 includes a cylindrical side wall 52 with an open top 54 and a closed bottom 56. Thus, when the lower cap 48 is fastened in place to the container 12, there is a supplements chamber 58 formed between the cylindrical side wall 52, the closed bottom 56 and the pour grille 24. Nutrient powder 3 is generally placed in this supplements chamber 58, as will be discussed below.

The insect enclosure 16, which is referred to above, is bounded by the cylindrical side walls 18 of the container 12, the upper cap 44 and the pour grille 24. The pour grille 24 has numerous openings 34 connecting to the supplement chamber 58, but these holes are too small for the crickets to pass through and thus crickets are confined within the insect enclosure 16.

FIG. 3 is a top plan view of the upper cap 44. The upper cap 44 also has a cylindrical side wall 60, and a top surface 62 which is mostly enclosed, but which includes an insertion aperture 64. This insertion aperture 64 is preferably elliptical in shape, and configured to receive the extraction tube 14, preferably at an angle. The upper cap 44 also includes a rotatable cover segment 66, which is rotatably hinged by a central hub 68. This central hub 68 includes a pivotable fastener 70, which is attached to the center of the top surface 62. The cover segment 66 thus is allowed to rotate about the central hub 68 to a first position where it closes over the insertion aperture 64 when the extraction tube 14 has been removed, thus sealing it off, and to a second position when the insertion aperture 64 is to be opened. When the cover segment 66 is in closed position, the insect enclosure 16 is thus completely sealed, and can be shaken without losing powder through the insertion aperture 64 of the upper cap 44, as will be described below. A first stop guide 72 and a second stop guide 74 are protrusions formed in the top surface 62, and these stop guides limit the range of rotation of the cover segment 66 about the central hub 68 in the open and closed positions.

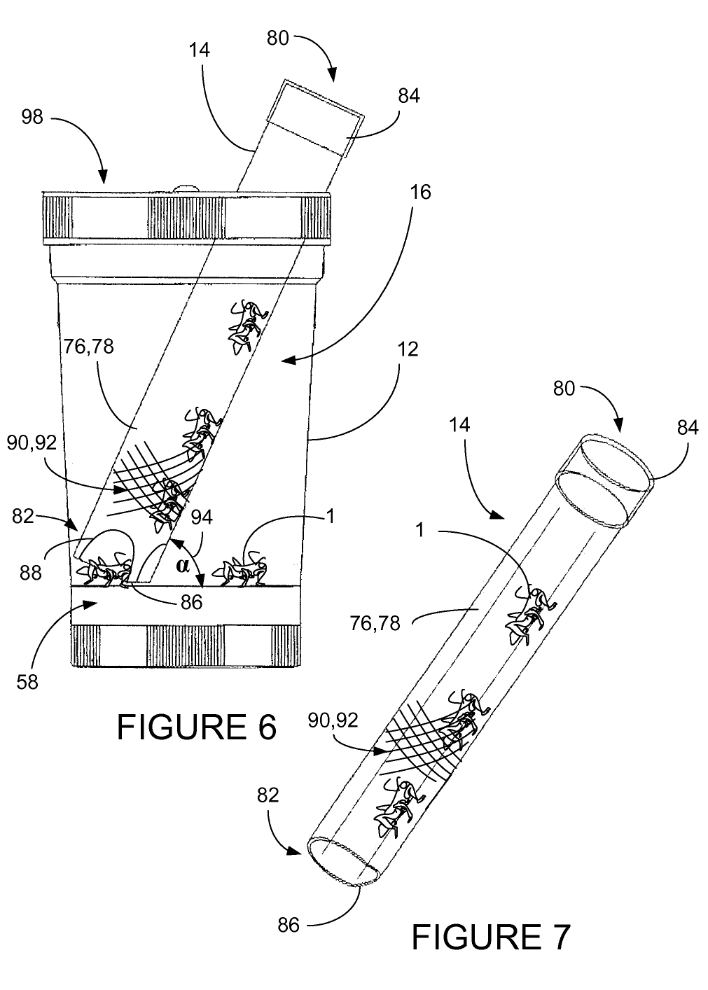

FIGS. 6 and 7 show the container 12 and extraction tube 14 in use with crickets 1. The extraction tube 14 includes a central tube 76 preferably having cylindrical side walls 78 with a top opening 80 and a bottom opening 82. A removable cap 84 fits over the top opening 82. The bottom opening preferably has a beveled portion 86, or one or more end side openings 88 through which the crickets 1 can enter. The cylindrical side walls 78 also have an inner surface 90, which is preferably a textured surface area 92 on some or the entire inner surface 90. This allows the crickets 1 to climb the interior of the tube 76 more easily.

Thus, in operation, the crickets 1 are placed in the insect enclosure 16 through the open top 20 of the container 12. The upper cap 44 is then screwed on to the container upper screw threads 40 (see also FIG. 2) to retain the crickets 1 in the insect enclosure 16. The cover segment 66 is rotated to close the insertion aperture 64. The lower cap 48 is then removed and the supplements chamber 58 is filled with nutrient powder 3 (see FIG. 2). The lower cap 48 is then replaced on the container 12. The container 12 is then shaken and the nutrient powder 3 falls through the openings 34 in the pour grille 24, and dusts the crickets 1 with nutrient powder 3. The cover segment 66 is then rotated to uncover the insertion aperture 64. The extraction tube 14 is inserted through the insertion aperture 64 into the interior of the insect enclosure 16, preferably at an angle α 94, (see FIG. 6) until the tube bottom 82 rests on the pour grille 24 at the bottom of the insect enclosure 16. The cap 84 is preferably on the tube top end 80. The crickets 1 then can enter the extraction tube 14 by the end side openings 88 or through the gap left between the angled tube bottom 82 and the pour grille 24. The crickets 1 then can climb the interior surface 90 of the extraction tube 14, gaining footing on the textured surface area 92.

As mentioned above, the extraction tube 14 is preferably introduced at an angle α 94 to the pour grille 24, which aids the crickets 1 to climb the inner surface 90 of the extraction tube 14. This angle α 94 in the preferred embodiment is 65 degrees, but is more generally preferably in the range of 60 to 90 degrees to the pour grille 24, but this too is not intended as a limitation, as it is possible that crickets 1 can still climb the interior surface 90 of the extraction tube 14 if the tube is vertically oriented. The angle of the extraction tube 14 is facilitated by the position and shape of the aperture 64 in the upper cap 44. As can be seen in FIG. 3, the aperture 64 is preferably positioned away from the center of the upper cap 44, towards its outer circumference. This allows the tube bottom 82 of the extraction tube 14 to be displaced horizontally at its greatest distance from the tube top 80, in other words, tilted at an angle rather than vertically aligned. This allows for the smallest angle α 94, and therefore the least steep gradient for the crickets 1 to climb inside the extraction tube 14. The easier gradient of the extraction tube 14 is also facilitated by the shape of the insertion aperture 64, which is preferably elliptical. A circular aperture being of the same approximate outer diameter of the extraction tube, would restrain the extraction tube to a nearly vertical orientation. In comparison, the preferred elliptical aperture 96 allows the angling of the extraction tube 14 inside the insect enclosure 16. Thus, the elliptical shape of the insertion aperture 64 also facilitates the extraction of the crickets 1.

Since both the container 12 and the extraction tube 14 are preferably transparent, the user can watch and decide when enough crickets 1 have entered the extraction tube 14. The extraction tube 14 can then be removed from the insertion aperture 64, and the cover segment 66 can be rotated to close the insertion aperture 64. The extraction tube 14 can them be shaken over the reptile's terrarium to dislodge the crickets 1. Alternatively, the entire extraction tube 14 can be placed into the terrarium with the cap 84 removed, where the crickets 1 may eventually wander out of the extraction tube 14 and be eaten by the user's reptile. As another possibility, the extraction tube 14 may be left in place extending into the insect enclosure 16 with the extraction tube's cap 84 removed. Reptiles such as chameleons can then feed on crickets 1 which climb to the open top 80 of the tube 14.

Thus, generally, it is possible to think of the insect dusting apparatus 10 as including a dusting enclosure 98, which includes the cylindrical walls 18 of the container 12, the lower cap 48, and the upper cap 44 and the upper cap 44 includes the insertion aperture 64 and its cover segment 66. Together, these elements make the dusting enclosure 98, which can be shaken without nutrient powder or other dusting supplements escaping. Within the dusting enclosure 98 are contained the insect enclosure 16 and the supplements chamber 58, which are connected by openings 34 in the pour grille 24 which separates them. Crickets 1 are introduced into the insect enclosure 16, nutrient powders 3 are placed in the supplements chamber 58, and the dusting enclosure 98 is shaken to introduce the nutrient powders 3 into the insect enclosure 16 to dust the crickets 1.

Although the insect dusting apparatus 10 can be made to any convenient dimensions, in the currently preferred embodiment, the container 12, along with upper cap 44 and lower cap 48 measures 148 mm from top to bottom. The upper cap 44 preferably has an outer diameter of 90 mm, the lower cap 48 preferably has an outer diameter of 72 mm, and the extraction tube 14 preferably has an outer diameter of 25 mm. These preferred dimensions are not to be taken as limitations however, and it will be understood that much variation is possible, as will be obvious to those skilled in the art.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

### INDUSTRIAL APPLICABILITY

The present insect dusting apparatus 10 is well suited for application in preparing insects for feeding to pets reptiles.

The cricket is an integral part of the diet of most domestic reptiles. However, most reptiles living in the wild have access to various nutrients which cannot be obtained by a steady diet of crickets alone. A deficiency of these nutrients can lead to illness and shortened life expectancy. Thus, to maintain the health of their pets, the pet owner may be required to provide supplements such as calcium, and other vitamins and nutrients, through supplement mixtures as nutrient additives or other commercial supplements.

The easiest way to persuade a reptile to consume essential nutrients is by introducing it into its food, including live crickets. Thus an apparatus which can easily dust insects with nutrient powders for consumption by reptile pets and aid in dispensing these insects will be very useful to these pet owners.

The insect dusting apparatus 10 of the present invention includes a dusting enclosure 98, which includes the cylindrical walls 18 of the container 12, the lower cap 48, and the upper cap 44. The upper cap 44 includes the insertion aperture 64 and its cover segment 66. Within the dusting enclosure 98 are contained the insect enclosure 16 and the supplements chamber 58, which are connected by openings 34 in the pour grille 24 which separates them.

Crickets 1 are placed in the insect enclosure 16 through the open top 20. The upper cap 44 is then screwed on to the container upper screw threads 40 to retain the crickets 1 in the insect enclosure 16. The cover segment 66 closes the insertion aperture 64. The lower cap 48 is then removed and the supplements chamber 58 is filled with nutrient powder 3, and the lower cap 48 is then replaced. The container 12 is then shaken and the nutrient powder 3 falls through the openings 34 in the pour grille 24, and dusts the crickets 1 with nutrient powder 3. The cover segment 66 is then rotated to uncover the insertion aperture 64. The extraction tube 14 is inserted through the insertion aperture 64 into the interior of the insect enclosure 16, preferably at an angle α 94, until the tube bottom 82 rests on the pour grille 24 at the bottom of the insect enclosure 16. The cap 84 is optionally secured on the tube top end 80. The crickets 1 then can enter the extraction tube 14 and can climb the interior surface 90 of the extraction tube 14, gaining footing on the textured surface area 92.

When the user has decided that enough crickets 1 have climbed the interior surface 90, the extraction tube 14 is removed from the insertion aperture 64, and the cover segment 66 is rotated to close the insertion aperture 64. The extraction tube 14 can then be shaken over the reptile's terrarium to dislodge the crickets 1, or the entire extraction tube 14 can be placed into the terrarium with the cap 84 removed. Alternately, the extraction tube 14 may be left in place extending into the insect enclosure 16 with the extraction tube's cap 84 removed, so that reptiles such as chameleons can then feed on crickets 1 which climb to the open top 80 of the tube 14.

For the above, and other, reasons, it is expected that insect dusting apparatus 10 of the present invention will have widespread industrial applicability. therefore, it is expected that the commercial utility of the present invention will be extensive and long lasting.

What is claimed is:

1. An apparatus for applying nutrient powders to insects and feeding them to reptiles, comprising:
a container having side walls, a top end and a bottom end;
an upper cap removably attached to said top end of said container;
a lower cap removably attached to said bottom end of said container, said lower cap including a supplement chamber to receive nutrient powder;
a pour grille positioned within said container between said top end and said bottom end, said side walls, said upper cap and said pour grille forming an insect enclosure which can contain insects placed within said insect enclosure, and said pour grille including a plurality of openings between said insect enclosure and said supplement chamber; and
said upper cap having an insertion aperture for receiving an extraction tube, and having a cover segment which can be positioned to cover said insertion aperture when said extraction tube is not engaged, so that the container can be shaken without spilling said nutrient powder.

2. The apparatus of claim 1, further comprising:
an extraction tube, which is configured to fit through said aperture of said upper cap and into said insect enclosure of said container for extracting insects from said container.

3. The apparatus of claim 1, wherein:
said extraction tube includes a tube top, a tube bottom, and an internal surface.

4. The apparatus of claim 1, wherein said tube bottom includes a beveled portion.

5. The apparatus of claim 1, wherein said tube bottom includes at least one end side opening.

6. The apparatus of claim 1, further comprising a cap which closes said top of said extraction tube.

7. The apparatus of claim 1, wherein said internal surface includes a textured inner surface.

8. The apparatus of claim 1, wherein said cover segment is rotatably fastened by a pivot and rotatable to a first position covering said insertion aperture and to a second position, where said insertion aperture is open.

9. The apparatus of claim 1, wherein said upper cap includes first and second stop guides to limit the travel of said cover segment.

10. The apparatus of claim 1, wherein said insertion aperture is positioned near the circumference of said upper cap, and is of an elliptical shape, such that said extraction tube can be inserted into said insect enclosure at a non-vertical angle.

11. The apparatus of claim 10, wherein said non-vertical angle of said extraction tube is in the range of 60 to 90 degrees.

12. A dusting enclosure for applying nutrient powders to insects and extracting them to feed to reptiles, comprising:
an insect enclosure including a reclosable insertion aperture, through which an extraction tube may be inserted; and
a supplements chamber, where said insect enclosure and said supplements chamber are separated by a pour grille, and where said insect enclosure and said supplements chamber are connected by openings in the pour grille.

13. The dusting enclosure of claim 12, wherein:
said insect enclosure includes a container having side walls, a top end and a bottom end, an upper cap removably attached to said top end of said container, and said pour grille positioned within said container between said top end and said bottom end.

14. The dusting enclosure of claim 12, wherein:
said reclosable insertion aperture is included in said upper cap.

15. The dusting enclosure of claim 12, wherein:
said upper cap includes a cover segment which is rotatably fastened by a pivot and which is rotatable to cover said insertion aperture.

16. The dusting enclosure of claim 15, wherein said upper cap further includes first and second stop guides to limit the travel of said cover segment.

17. The dusting enclosure of claim 14, wherein said insertion aperture is positioned near the circumference of said upper cap, and is of an elliptical shape, such that said extraction tube can be inserted into said insect enclosure at a non-vertical angle.

18. A method of applying nutrient powders to insects to prepare them for feeding to reptiles, comprising:
a) providing a container having side walls, a top end and a bottom end, a upper cap removably attached to said top end of said container, a lower cap removably attached to said bottom end of said container, said lower cap including a supplement chamber to receive nutrient powder, a pour grille positioned within said container between said top end and said bottom end, said side walls, said upper cap and said pour grille forming an insect enclosure, said pour grille including a plurality of openings between said insect enclosure and said supplement chamber, said upper cap having an insertion aperture for receiving an extraction tube, and also having a cover segment which can be positioned to cover said insertion aperture when said extraction tube is not engaged;
b) placing at least one insect in said insect enclosure;
c) placing nutrient powder in said supplement chamber;
d) closing said cover segment over said insertion aperture;
e) shaking said container so that nutrient powder is introduced into said insect enclosure through said pour grille, and thus coating the at least one insect;
f) pivoting said cover segment to open said insertion aperture;
g) inserting said extraction tube through said insertion aperture into said insect enclosure;
h) allowing said at least one insect to enter said extraction tube; and
i) removing said extraction tube with said at least one insect from said insertion aperture to feed a reptile.
